(19) United States
(12) Patent Application Publication
(10) Pub. No.: US 2007/0244220 A1
(43) Pub. Date: Oct. 18, 2007

(54) Dispersion adjuvant for metal nanoparticles and metal nanoink comprising the same

(75) Inventors: Sang Ho Kim, Yuseong-gu (KR); Jong Taik Lee, Yuseong-gu (KR); Min Seo Kim, Yuseong-gu (KR); Soo Yeon Heo, Seo-gu (KR)

Correspondence Address: MCKENNA LONG & ALDRIDGE LLP, 1900 K STREET, NW, WASHINGTON, DC, 20006, US

(73) Assignee: LG CHEM, LTD., Youngdungpo-gu (KR)

(21) Appl. No.: 11/783,741

(22) Filed: Apr. 11, 2007

(30) Foreign Application Priority Data
Apr. 12, 2006 (KR) 10-2006-0033207

(51) Int. Cl. C09D 11/00

(52) U.S. Cl. 523/160; 523/161

(57) ABSTRACT

Disclosed is a dispersion adjuvant for metal nanoparticles, which comprises an amide derivative. Metal nanoink comprising the dispersion adjuvant is also disclosed. The dispersion adjuvant helps metal nanoparticles to be dispersed in a solvent in the presence of a dispersant, inhibits metal particles from agglomerating among themselves, and increases the content of metal nanoparticles in a solvent. Additionally, interconnection lines formed by using the nanoink have an increased content of metal per unit area, and thus provide improved conductivity.

This application claims the benefit of the filing date of Korean Patent Application No. 10-2006-0033207, filed on Apr. 12, 2006, in the Korean Intellectual Property Office, the disclosure of which is incorporated herein in its entirety by reference.

### BACKGROUND OF THE INVENTION

(a) Field of the Invention

The present invention relates to a dispersion adjuvant for metal nanoparticles, which is formed of an amide derivative, and metal nanoink comprising the same.

(b) Description of the Related Art

Many attempts have been made to perform circuit interconnection in various industrial fields including flat panel display (FPD). Known methods for circuit interconnection include an etching process using a photoresist, a screen printing process using a silver paste, a laser transfer process, or the like.

The etching process using a photoresist has an advantage in that it can realize a microcircuit. However, general etching processes include complicated processing steps and require expensive equipment. The screen printing process using a silver paste has an advantage of simplicity, but is problematic in that continuous exchange of screens is required and realization of an ultramicro-circuit is difficult. The laser transfer process includes the steps of coating expensive silver onto the front surface of a circuit and forming a desired circuit by using a laser. However, the laser transfer process is problematic in that consumption of a large amount of silver as an interconnection material is required.

As compared to the above processes, a patterning process including a step of interconnecting a circuit via direct printing, i.e. a circuit interconnection process using ink jet printing is advantageous in that it can realize a microcircuit with ease, causes no waste of high-cost materials, and includes simple processing steps. Therefore, the ink jet printing process has been spotlighted as next-generation circuit interconnection technology. Particularly, when metal particles have a size of 200 nm or less, the particles have an increased surface area and an increased surface energy, so that they melt into a liquid state at low temperature, making it possible to form metal lines at a low temperature of 300° C. or lower.

In the ink jet printing process, metal ink comprising solvent, conductive metal particles, a dispersant and additives is ejected from an ink jet nozzle to perform printing, heat treatment is carried out to remove the solvent and the dispersant, and then circuit interconnection is performed by the remaining metal particles bound to each other.

Metal interconnection formed via the ink jet printing process provides a higher conductivity as the metal solid content in the ink increases, as the thickness of the resultant metal interconnection line increases, and as the amount of the organic residue remaining after the heat treatment reduces. Additionally, metal ink should have an adequate contact angle between ink droplets ejected from the nozzle and the surface of a substrate onto which the ink is jetted. Since the contact angle depends on the hydrophilicity of the ink droplets and that of the surface of the substrate, selection of the solvent for the ink is determined by the particular type of the substrate.

Most metal particles used in metal ink are nanoparticles having an average diameter of about 1˜150 nm. As the size of the metal particles decreases, the metal particles have a higher surface energy and a lower melting point, thereby forming metal lines at low temperature. However, when the metal particles have an increased surface energy, they have a strong tendency to agglomerate so as to reduce the surface energy. Thus, it is important to stabilize the surface of the metal particles.

In order to allow surface stabilization of the metal particles and to impart excellent dispersibility to the metal particles, it is necessary to provide a dispersant that is well bound to the metal particles so as to stabilize the surface energy and has high affinity to a solvent so as to be dispersed well in the solvent.

As a dispersant, a single molecule having a long alkyl chain may be used in the form of a surfactant. Also, a polymer having a coupling group and a functional group with an affinity to a solvent may be used as a dispersant.

However, even when using a dispersant, there are problems in that an increment in content of metal particles dispersed in a solvent is still limited and agglomeration of the metal particles may occur.

### SUMMARY OF THE INVENTION

It is an object of the present invention to provide a dispersion adjuvant for metal nanoparticles that can improve dispersion of the metal nanoparticles in the presence of a dispersant and inhibit agglomeration of the metal nanoparticles, and metal nanoink comprising the same.

In order to achieve the above-mentioned object, the present invention provides a dispersion adjuvant for metal nanoparticles, which comprises an amide derivative, and more particularly an amide derivative represented by the following Formula 1 or an amide derivative represented by the following Formula 2:

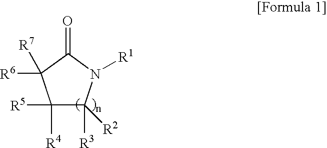

wherein each of R¹˜R⁷ independently represents —H, —F, —Cl, —Br, —I, —OH, —SH, —COOH, —PO₃H₂, —NH₂, —O(CH₂CH₂O)ₘH, a C₁˜C₁₂ alkyl, a C₁˜C₁₂ aminoalkyl, a C₁˜C₁₂ hydroxyalkyl, a C₁˜C₁₂ haloalkyl, a C₆˜C₁₈ aryl, a C₆˜C₁₈ aminoaryl, a C₆˜C₁₈ hydroxyaryl, a C₆˜C₁₈ haloaryl, a C₇˜C₁₈ benzyl, a C₇˜C₁₈ aminobenzyl, a C₇˜C₁₈ hydroxybenzyl, or a C₇˜C₁₈ halobenzyl; and each of m and n independently represents an integer of 1˜5.

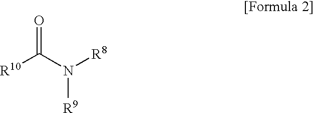

wherein each of R⁸˜ R¹⁰ independently represents —H, —OH, —SH, —COOH, —PO₃H₂, —NH₂, —O(CH₂CH₂O)ₘH, a C₁˜C₁₂ alkyl; a C₁˜C₁₂ aminoalkyl, a C₁˜C₁₂ hydroxyalkyl, a C₁˜C₁₂ haloalkyl, a C₂˜C₁₂ alkenyl, a C₆˜C₁₈ aryl, a C₆˜C₁₈ aminoaryl, a C₆˜C₁₈ hydroxyaryl, a C₆˜C₁₈ haloaryl, a C₇˜C₁₈ benzyl, a C₇˜C₁₈ aminobenzyl, a C₇˜C₁₈ hydroxybenzyl, or a C₇˜C₁₈ halobenzyl; and m is an integer of 1˜5.

Also, the present invention provides metal nanoink comprising: a dispersant; a dispersion adjuvant for metal nanoparticles comprising the amide derivative according to the present invention; metal nanoparticles; and a non-aqueous solvent.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a graph showing variations in TGA (thermogravimetric analysis) of Ag nanoink according to Example 1 and Comparative Example 1 as a function of time; and

FIG. 2 is a graph showing variations in viscosity of Ag nanoink according to Example 1 and Comparative Example 1 as a function of time.

### DETAILED DESCRIPTION OF THE INVENTION

Hereinafter, the present invention will be explained in more detail.

The dispersion adjuvant for metal nanoparticles according to the present invention is used in combination with a dispersant so as to inhibit the metal nanoparticles from agglomerating and to improve dispersibility of the metal nanoparticles.

Generally, metal nanoparticles forming metal nanoink tend to agglomerate or form lumps in a solvent, thereby showing poor dispersibility, and settle in the solvent in the form of agglomerates, resulting in degradation of usefulness of metal nanoink. Therefore, a dispersant having a good affinity to a solvent and capable of well dispersing the metal nanoparticles in the solvent is used to form metal nanoink.

Dispersants that may be used widely in the art include polymeric dispersants having oxygen (O) atom and/or nitrogen (N) atom. In such dispersants, oxygen atoms and nitrogen atoms have unpaired electrons, and thus the dispersants are capable of interaction with a metal, even though they are not bound to the metal. Such interaction makes it possible to disperse metal nanoparticles in a solvent.

The dispersion adjuvant according to the present invention comprises an amide derivative having hetero atoms, such as oxygen atoms and nitrogen atoms, having unpaired electrons. Therefore, the hetero atoms, such as oxygen atoms and nitrogen atoms, contained in the dispersion adjuvant according to the present invention, are capable of interaction with metal nanoparticles. Such interaction between the dispersion adjuvant and the metal nanoparticles serves to increase the interaction between a dispersant and metal nanoparticles, and thus facilitates dispersion of the metal nanoparticles in a solvent.

As mentioned above, the dispersion adjuvant for metal nanoparticles according to the present invention comprises an amide backbone-containing amide derivative represented by the above Formula 1 or Formula 2.

Non-limiting examples of the amide derivative represented by Formula 1 include 2-pyrrolidinone, N-methyl-2-pyrolidone (NMP, 1-methyl-2-pyrrolidinone), 3-methyl-2-pyrrolidinone, 5-methyl-2-pyrrolidinone, 1-butyl-2-pyrrolidinone, 3,3,5-trimethyl-2-pyrrolidinone, 1,5-dimethyl-2-pyrrolidinone, 1-phenyl-2-pyrrolidinone, 3-bromo-1-phenyl-2-pyrrolidinone, 3-amino-2-pyrrolidinone, N-(3-aminopropyl)-2-pyrrolidinone, 4-hydroxy-2-pyrrolidinone, 1-(hydroxymethyl)-2-pyrrolidinone, 5-(hydroxymethyl)-2-pyrrolidinone, 1-benzyl-2-pyrrolidinone, 1-(2-hydroxybenzyl)-2-pyrrolidinone, 3-azabicyclo[3.3.0]octan-2-one, or the like.

Non-limiting examples of the amide derivative represented by Formula 2 include N,N-dimethylformamide, N,N-dimethylacetamide, 2-chloro-N,N-dimethylacetamide, N-ethenyl-N-methylacetamide, N,N-dimethylpropanamide, N,N-2-trimethylpropanamide, N,N-dimethyl-2-oxo-acetamide, or the like.

Additionally, the amide derivative is present preferably in a liquid state at room temperature, since a dispersion adjuvant having good affinity and compatibility to a solvent provides high quality.

The metal nanoink according to the present invention comprises: a dispersant; a dispersion adjuvant for metal nanoparticles comprising the amide derivative according to the present invention; metal nanoparticles; and a non-aqueous solvent.

The dispersion adjuvant may be a compound that belongs to the same class as the functional group or terminal group contained in the dispersant. Otherwise, the dispersant may include the amide group of the dispersion adjuvant as a functional group or terminal group. In other words, the dispersion adjuvant may be a compound containing the functional group or terminal group contained in the dispersant.

For example, when the dispersant is polyvinyl pyrrolidone (PVP), each unit of polyvinyl pyrrolidone has a pyrrolidyl group, and thus a compound that belongs to the same class as pyrrolidyl group, such as N-methyl-2-pyrrolidone, may be used as the dispersion adjuvant. However, the scope of the present invention is not limited thereto. If the dispersant contained in metal nanoink is a polymer, such as polyvinyl pyrrolidone, having a high molecular weight, the polymer may have a limitation in serving as a dispersant for metal nanoparticles due to its functional groups or terminal groups (e.g. pyrrolidyl groups) adjacent to each other. However, when a dispersant adjuvant satisfying the above-mentioned requirement according to the present invention is contained in metal nanoink in combination with the dispersant, the dispersant adjuvant, which has a low molecular weight and is capable of interaction with metal nanoparticles, partially substitutes for the functions of the dispersant while increasing the interaction between the dispersant and the metal nanoparticles, thereby improving dispersion of the metal nanoparticles in a solvent.

The dispersion adjuvant may be used in metal nanoink in an amount of 0.1˜15 parts by weight per 100 parts by weight of the total metal nanoink. When the dispersion adjuvant is used in an amount less than 0.1 parts by weight, it is not possible to sufficiently improve dispersion of metal nanoparticles in a solvent. If the dispersion adjuvant is used in an amount greater than 15 parts by weight, the solid content (metal nanoparticles) decreases accordingly, resulting in an undesired drop in conductivity.

There is no particular limitation in the dispersant, as long as the dispersant is a currently used dispersant for metal nanoink. Particularly, dispersants that may be used in the present invention include polymeric dispersants containing oxygen atoms (O) and/or nitrogen atoms (N) and having a molecular weight of 2000 or more.

Non-limiting examples of the polymeric dispersants include polyvinyl pyrrolidone (PVP), polyethylene imine (PEI), polymethyl vinyl ether (PMVE), polyvinyl alcohol (PVA), polyoxyethylene alkyl phenyl ether, polyethylene sorbitan monostearate or derivatives thereof. The above dispersants may be used alone or in combination.

Additionally, there is no particular limitation in the amount of the dispersant in the metal nanoink according to the present invention. Preferably, the dispersant is used in an amount of 0.01˜10 parts by weight based on 100 parts by weight of the total metal nanoink. If the dispersant is used in an amount less than 0.01 parts by weight based on 100 parts by weight of the metal nanoink, it is not possible to sufficiently disperse metal nanoparticles in a solvent. If the dispersant is used in an amount greater than 10 parts by weight, the solid content (metal nanoparticles) decreases accordingly, resulting in an undesired drop in conductivity and increase in viscosity.

The metal nanoparticles that may be used in the present invention include at least one particles selected from the group consisting of: transition metals selected from Ag, Au, Pd, Pt, Ni, Cu, Cr, Al, W, Zn, Fe and Pb; alloys of the transition metals; sulfides of the transition metals; carbides of the transition metals; oxides of the transition metals; nitrides of the transition metals; and salts of the transition metals.

Additionally, the metal nanoparticles are used in an amount of 0.1˜90 parts by weight, preferably 0.1˜70 parts by weight, based on 100 parts by weight of the total metal nanoink. If the metal nanoparticles are used in an amount less than 0.1 parts by weight based on 100 parts by weight of the metal nanoink, it is not possible to form an interconnection line or film having a sufficient thickness and conductivity. If the metal nanoparticles are used in an amount greater than 90 parts by weight, the resultant metal nanoink has a decreased flowability and shows low dispersibility in a solvent.

Further, there is no particular limitation in the non-aqueous solvent in the metal nanoink according to the present invention, as long as the solvent can impart flowability to the ink and is a currently used non-aqueous solvent for ink. Non-limiting examples of the non-aqueous solvent include alcohols, glycols, polyols, glycol ethers, glycol ether esters, ketones, hydrocarbons, lactates, esters, aprotic sulfoxides, nitriles, or the like.

Particular examples of the non-aqueous solvent that may be used in the metal nanoink according to the present invention include methanol, ethanol, propanol, isopropanol, butanol, pentanol, hexanol, ethylene glycol, propylene glycol, glycerol, ethylene glycol monomethyl ether, ethylene glycol monoethyl ether, ethylene glycol dimethyl ether, ethylene glycol diethyl ether, propylene glycol propyl ether, ethylene glycol monophenyl ether, ethylene glycol monoisopropyl ether, THF, propylene glycol methyl ether acetate, methyl isobutyl ketone, methyl ethyl ketone, hexadecane, pentadecane, tetradecane, tridecane, dodecane, undecane, decane, nonane, octane, heptane, hexane, xylene, toluene, benzene, DMSO, acetonitrile, or the like. However, the scope of the present invention is not limited thereto.

Additionally, the above non-aqueous solvents may be selected considering the viscosity, dispersibility and solvent volatility of metal nanoink to be provided, and may be used alone or in combination.

The metal nanoink according to the present invention may be used as ink for circuit interconnection.

For example, the metal nanoink is applied to an ink jet printing process using an ink jet nozzle for ejecting the ink, and then heat treatment is performed to form metal interconnection lines. The above heat treatment may be carried out at a temperature of 150˜500° C. Such heat treatment allows the dispersant and the dispersant adjuvant to be pyrolyzed and removed.

Therefore, the present invention also provides a conductive interconnection line or film formed by using the metal nanoink comprising a dispersant, a dispersion adjuvant comprising the amide derivative according to the present invention, metal nanoparticles and a solvent. A circuit comprising the above conductive interconnection line or film is also included in the scope of the present invention.

Reference will now be made in detail to the preferred embodiments of the present invention. It is to be understood that the following examples are illustrative only and the present invention is not limited thereto.

### EXAMPLE 1

First, 50 wt % of Ag nanoparticles having a D₅₀ of 70 nm and obtained by the polyol process was provided. Then, 1 wt % of polyvinyl pyrrolidone (PVP) having a molecular weight of 55,000 was provided as a dispersant, and 15 wt % of N-methyl-2-pyrrolidone (NMP) was provided as a dispersion adjuvant. Further, a mixed solvent containing 15 wt % of 2-phenoxyethanol, 10 wt % of isopropyl glycol, 4 wt % of glycerol and 5 wt % of ethanol was provided. The above materials were mixed rigorously by using a shaker at room temperature (25° C.) for 24 hours to provide silver nanoink.

### COMPARATIVE EXAMPLE 1

Ag nanoink was provided in the same manner as described in Example 1, except that N-methyl-2-pyrrolidone (NMP) was not used and 2-phenoxyethanol was further used.

### EXPERIMENTAL EXAMPLE

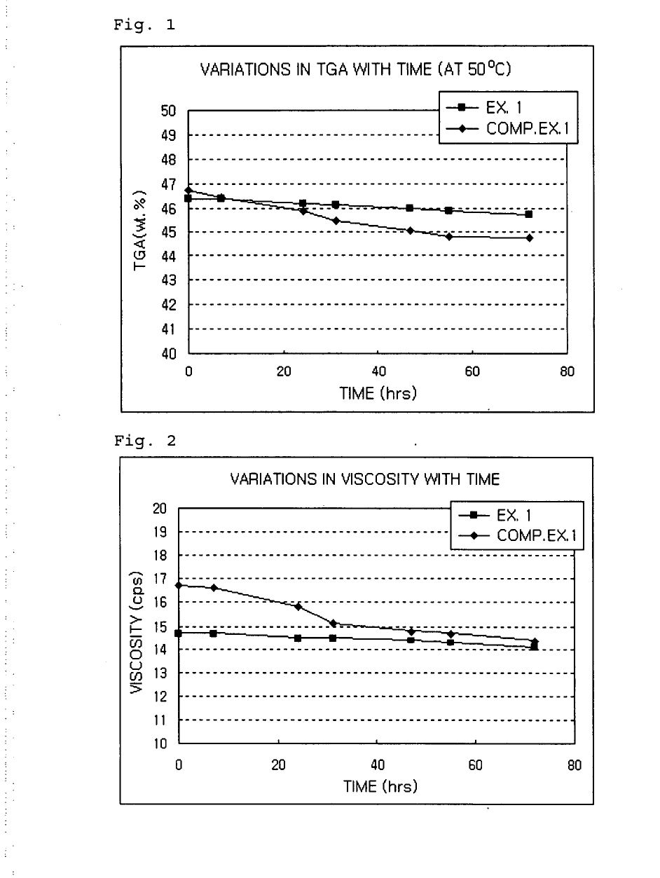

Each Ag nanoink obtained from Example 1 and Comparative Example 1 was stored in an oven at 50° C. for 3 days, while measuring variations in viscosity and TGA. The results are shown in the following Table 1 and FIGS. 1 and 2.

TABLE 1

| | |
|---|---|
| | Viscosity (cps) |
| TGA (wt %) | (shear rate: 75/sec) |

| Time | | Comp. | | Comp. |
|---|---|---|---|---|
| (hours) | Ex. 1 | Ex. 1 | Ex. 1 | Ex. 1 |
| 0 | 46.40 | 46.72 | 14.7 | 16.7 |
| 7 | 46.36 | 46.45 | 14.7 | 16.6 |
| 24 | 46.17 | 45.89 | 14.5 | 15.8 |
| 31 | 46.11 | 45.46 | 14.5 | 15.1 |
| 46 | 45.99 | 45.07 | 14.4 | 14.8 |
| 72 | 45.87 | 44.81 | 14.3 | 14.7 |

As can be seen from the variations in TGA of each nanoink with time (Table 1 and FIG. 1), the silver nanoink (Example 1) containing NMP shows a smaller variance in TGA when compared to the silver nanoink (Comparative Example 1) containing no NMP. Additionally, as can be seen from the variations in viscosity of each ink with time (Table 1 and FIG. 2), the silver nanoink (Example 1) containing NMP shows a smaller variance in viscosity when compared to the silver nanoink (Comparative Example 1) containing no NMP.

Therefore, it can be seen from the above results that the silver nanoink using NMP as a dispersion adjuvant according to Example 1 allows a greater amount of silver nanoparticles to be dispersed in a solvent and has a higher solid content, when compared to the silver nanoink containing no NMP according to Comparative Example 1. Also, the silver nanoink according to Example 1 inhibits metal nanoparticles from agglomerating among themselves. Further, because the silver nanoink according to Example 1 has an increased solid content when compared to the silver nanoink according to Comparative Example 1, metal lines formed by using the silver nanoink according to Example 1 can provide improved conductivity.

The dispersion adjuvant according to the present invention helps metal nanoparticles to be dispersed in a solvent in the presence of a dispersant, inhibits metal particles from agglomerating among themselves, and increases the content of metal nanoparticles in a solvent. Additionally, interconnection lines formed by using the nanoink according to the present invention have an increased content of metal per unit area, and thus provide improved conductivity.

Although several preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A dispersion adjuvant for metal nanoparticles, which comprises an amide derivative represented by the following Formula 1 or an amide derivative represented by the following Formula 2: 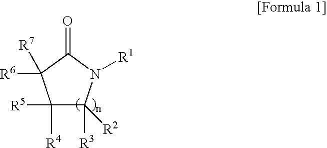
wherein each of R¹˜ R⁷ independently represents —H, —F, —Cl, —Br, —I, —OH, —SH, —COOH, —PO₃H₂, —NH₂, —O(CH₂CH₂O)ₘH, a C₁˜C₁₂ alkyl, a C₁˜C₁₂ aminoalkyl, a C₁˜C₁₂ hydroxyalkyl, a C₁˜C₁₂ haloalkyl, a C₆˜C₁₈ aryl, a C₆˜C₁₈ aminoaryl, a C₆˜C₁₈ hydroxyaryl, a C₆˜C₁₈ haloaryl, a C₇˜C₁₈ benzyl, a C₇˜C₁₈ aminobenzyl, a C₇˜C₁₈ hydroxybenzyl, or a C₇˜C₁₈ halobenzyl; and each of m and n independently represents an integer of 1˜5. 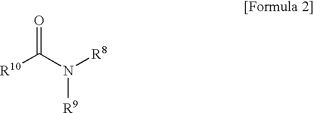
wherein each of R⁸˜ R¹⁰ independently represents —H, —OH, —SH, —COOH, —PO₃H₂, —NH₂, —O(CH₂CH₂O)ₘH, a C₁˜C₁₂ alkyl; a C₁˜C₁₂ aminoalkyl, a C₁˜C₁₂ hydroxyalkyl, a C₁˜C₁₂ haloalkyl, a C₂˜C₁₂ alkenyl, a C₆˜C₁₈ aryl, a C₆˜C₁₈ aminoaryl, a C₆˜C₁₈ hydroxyaryl, a C₆˜C₁₈ haloaryl, a C₇˜C₁₈ benzyl, a C₇˜C₁₈ aminobenzyl, a C₇˜C₁₈ hydroxybenzyl, or a C₇˜C₁₈ halobenzyl; and m is an integer of 1˜5.

2. The dispersion adjuvant for metal nanoparticles as claimed in claim 1, wherein the amide derivative represented by Formula 1 includes 2-pyrrolidinone, N-methyl-2-pyrolidone, 3-methyl-2-pyrrolidinone, 5-methyl-2-pyrrolidinone, 1-butyl-2-pyrrolidinone, 3,3,5-trimethyl-2-pyrrolidinone, 1,5-dimethyl-2-pyrrolidinone, 1-phenyl-2-pyrrolidinone, 3-bromo-1-phenyl-2-pyrrolidinone, 3-amino-2-pyrrolidinone, N-(3-aminopropyl)-2-pyrrolidinone, 4-hydroxy-2-pyrrolidinone, 1-(hydroxymethyl)-2-pyrrolidinone, 5-(hydroxymethyl)-2-pyrrolidinone, 1-benzyl-2-pyrrolidinone, 1-(2-hydroxybenzyl)-2-pyrrolidinone, or 3-azabicyclo[3.3.0]octan-2-one.

3. The dispersion adjuvant for metal nanoparticles as claimed in claim 1, wherein the amide derivative represented by Formula 2 includes include N,N-dimethylformamide, N,N-dimethylacetamide, 2-chloro-N,N-dimethylacetamide, N-ethenyl-N-methylacetamide, N,N-dimethylpropanamide, N,N-2-trimethylpropanamide, or N,N-dimethyl-2-oxo-acetamide.

4. The dispersion adjuvant for metal nanoparticles as claimed in claim 1, wherein the amide derivative is present in a liquid state at room temperature.

5. A metal nanoink comprising: a dispersant; a dispersion adjuvant for metal nanoparticles comprising the amide derivative as defined in claim 1; metal nanoparticles; and a non-aqueous solvent.

6. The metal nanoink as claimed in claim 5, wherein the dispersion adjuvant is a compound that belongs to the same class as a functional group or terminal group contained in the dispersant.

7. The metal nanoink as claimed in claim 5, wherein the dispersion adjuvant is used in an amount of 0.1˜15 parts by weight based on 100 parts by weight of the total metal nanoink.

8. The metal nanoink as claimed in claim 5, wherein the dispersant includes a polymeric dispersant containing oxygen atom (O), nitrogen atom (N) or both, and having a molecular weight of 2000 or more.

9. The metal nanoink as claimed in claim 8, wherein the polymeric dispersant is at least one dispersant selected from the group consisting of polyvinyl pyrrolidone (PVP), polyethylene imine (PEI), polymethyl vinyl ether (PMVE), polyvinyl alcohol (PVA), polyoxyethylene alkyl phenyl ether and polyethylene sorbitan monostearate.

10. The metal nanoink as claimed in claim 5, wherein the metal nanoparticle is at least one particles selected from the group consisting of: transition metals selected from Ag, Au, Pd, Pt, Ni, Cu, Cr, Al, W, Zn, Fe and Pb; alloys of the transition metals; sulfides of the transition metals; carbides of the transition metals; oxides of the transition metals; nitrides of the transition metals; and salts of the transition metals.

11. The metal nanoink as claimed in claim 5, wherein the solvent is at least one solvent selected from the group consisting of alcohols, glycols, polyols, glycol ethers, glycol ether esters, ketones, hydrocarbons, lactates, esters, aprotic sulfoxides and nitriles.

12. The metal nanoink as claimed in claim 5, which is for use in circuit interconnection.

13. The metal nanoink as claimed in claim 5, wherein the amide derivative represented by Formula 1 includes 2-pyrrolidinone, N-methyl-2-pyrolidone, 3-methyl-2-pyrrolidinone, 5-methyl-2-pyrrolidinone, 1-butyl-2-pyrrolidinone, 3,3,5-trimethyl-2-pyrrolidinone, 1,5-dimethyl-2-pyrrolidinone, 1-phenyl-2-pyrrolidinone, 3-bromo-1-phenyl-2-pyrrolidinone, 3-amino-2-pyrrolidinone, N-(3-aminopropyl)-2-pyrrolidinone, 4-hydroxy-2-pyrrolidinone, 1-(hydroxymethyl)-2-pyrrolidinone, 5-(hydroxymethyl)-2-pyrrolidinone, 1-benzyl-2-pyrrolidinone, 1-(2-hydroxybenzyl)-2-pyrrolidinone, or 3-azabicyclo[3.3.0]octan-2-one.

14. The metal nanoink as claimed in claim 5, wherein the amide derivative represented by Formula 2 includes include N N-dimethylformamide, N,N-dimethylacetamide, 2-chloro-N,N-dimethylacetamide, N-ethenyl-N-methylacetamide, N,N-dimethylpropanamide, N,N-2-trimethylpropanamide, or N,N-dimethyl-2-oxo-acetamide.

15. The metal nanoink as claimed in claim 5, wherein the amide derivative is present in a liquid state at room temperature.
